(19) United States
(12) Patent Application Publication
(10) Pub. No.: US 2014/0163217 A1
(43) Pub. Date: Jun. 12, 2014

(54) PROCESS FOR THE ESTERIFICATION OF HYALURONIC ACID WITH HYDROPHOBIC ORGANIC COMPOUNDS

(71) Applicants: Michael Moeller, Arzier (CH); Beatrice Kaufmann, Petit-Lancy (CH); Robert Gurny, Geneva (CH)

(72) Inventors: Michael Moeller, Arzier (CH); Beatrice Kaufmann, Petit-Lancy (CH); Robert Gurny, Geneva (CH)

(73) Assignee: UNIVERSITE DE GENEVE, Geneva (CH)

(21) Appl. No.: 13/813,114

(22) PCT Filed: Jul. 26, 2011
(86) PCT No.: PCT/EP2011/062823

§ 371 Date: Apr. 22, 2013

Related U.S. Application Data
(60) Provisional application No. 61/368,672, filed on Jul. 29, 2010.

(51) Int. Cl. C08B 37/08

(52) U.S. Cl. CPC C08B 37/0072
USPC 536/53

(57) ABSTRACT

The invention relates to a process for providing esters of hyaluronic acid, hyaluronic acid salts or hyaluronic acid derivatives with hydrophobic organic compounds. The process includes the steps of (i) micronizing the hyaluronic acid, salt or derivative thereof at reduced temperature, (ii) reacting the hydrophobic compound with a micronized hyaluronic acid obtained in (i) in a suitable solvent; and (iii) filtrating or dialyzing reaction mixture obtained in (ii) to obtain the desired ester. Also encompassed by the present invention are the esters obtained by such a method and compositions containing them as well as the use thereof for treating and/or preventing cartilage damage and inflammation.

### FIELD OF THE INVENTION

The present invention relates to a process for the preparation of esters of hyaluronic acid (HA) as well as salts and derivatives thereof with hydrophobic organic compounds.

### BACKGROUND

Hyaluronic acid is a natural mucopolysaccharide formed of alternating units of D-glucuronic acid and N-acetylglucosamine in a linear chain having a molecular weight of up to 13×10⁶ Daltons. Hyaluronic acid is present in all the soft tissues of the organism and in many physiological tissues such as, for example, the synovial fluid and the cartilage of the joints and the skin.

Hyaluronic acid and its salts, in particular its sodium salt, has been used for many years for intra-articular administration with the objective to replace hyaluronic acid normally present in the synovial fluid that has been degraded or diminished as a result of certain diseases and disorders of the joints. In eye surgery, hyaluronic acid is in use as a temporary filler for the anterior chamber of the eye and as a lubricant for surgical instruments.

Specifically, sodium hyaluronate is used with great success in the treatment of joint inflammation, where it is administered by intra-articular injection and acts via a dual mechanism: its anti-inflammatory effect, which is at least partially due to its free radical scavenging capability, and its lubricating effect, which is due to the increase of the viscosity of the synovial fluid caused by the hyaluronate. Moreover, hyaluronate has a beneficial effect on cartilage repair and thus can supplement therapies that aim at restoring cartilage tissue at cartilage defect sites.

Hyaluronate is also of use in ophthalmology and dermatology, where it is used for its protective, lubricating and anti-inflammatory properties and for wound and tissue repair.

However, one significant disadvantage of hyaluronic acid and its salts is their susceptibility to degradation by hydrolysis of the glycosidic bonds of the polysaccharide chain. The hydrolysis rate is significantly influenced by temperature, pH value and ion concentration.

It has been found that the esterification of the hydroxy groups of hyaluronic acid can at least partially negate the susceptibility to depolymerization. However, the esterification of hyaluronic acid with hydrophobic organic compounds, such as anthracene carboxylic acids and derivatives thereof, remains challenging due to the hydrophilicity of hyaluronic acid and its salts.

Rhein, of which the chemical name is 4,5-dihydroxy-9,10-dihydro-9,10-dioxo-2-anthracene carboxylic acid, is an alkaloid derivative from plants, such as senna, rhubarb and aloe vera, which has anti-inflammatory and tissue-protecting properties and is used in treating inflammation of the joints. Its anti-inflammatory effect is achieved by inhibition of the synthesis of interleukin-1 (IL-1) and the IL-1 controlled production of nitric oxide (NO), which are among the agents responsible for cartilaginous degeneration.

Usually rhein is administered via the oral route as its prodrug, diacetylrhein or diacerhein, which has, compared to rhein, an improved bioavailability and is authorized for oral use in various European countries for the treatment of osteoarthritis. However, both rhein and diacetylrhein present the drawback of having a considerable laxative action, which can even lead to diarrhea and thus make use thereof unadvisable for old or debilitated patients. Moreover, on account of the insolubility of rhein and diacetylrhein in water, this side effect cannot be obviated by administering these compounds via the parenteral or intra-articular route. In addition, the active compound, rhein, has a very short half-life and is rapidly eliminated. Finally, diacerhein is susceptible to premature hydrolysis into rhein in the stomach.

These characteristics—low absorption, laxative effects, rapid elimination, hydrolysis of diacerhein in the stomach—give reason to the poor tolerability of oral diacerhein therapy. It would thus be desirable to use local administration in the target area.

However, intra-articular administration of diacerhein is difficult to realize due to the lack of solubility of the drug in a carrier compatible with a synovial liquid, and because of its short half-life in the joint, which has been shown to be too short for an effective block of IL-1 synthesis.

International patent application WO 2005/085293 describes esters of hyaluronic acid with rhein, which are prepared by reacting hyaluronic acid with rhein chloride and subsequent purification by ultrafiltration or dialysis. However, the method disclosed in this document provides the desired esters of hyaluronic acid with rhein only in very low yields.

Another method for the formation of esters of hyaluronic acid with diacerhein is described in European patent application No. 07 021 621.3. The described method includes use of diacerhein wherein the carboxylic acid group has been protected by reaction with an N-carbonyldimidazole (CDI) in accordance with a classic method used to esterify amino acids. The synthesis of imidazolyl diacerheinate (CDIDIAC) is achieved by stoichiometric reaction in anhydrous organic solvent, for example DMF, at a temperature of 30-40° C. For the esterification reaction, the hyaluronic acid has to be solubilized in an organic solvent, and is therefore first salified with a strong quaternary base, such as tetrabutyl ammonium hydroxide, to yield hyaluronic acid tetrabutyl ammonium salt, which is soluble in organic solvents. The esterification reaction is carried out under nitrogen at a temperature lower than 40° C. with reaction times of about 48 hours.

This method has the drawback that it requires labor-intensive salification and solubilization of the hyaluronic acid, which is necessary to bring the hyaluronic acid molecules in contact with its reaction partner CDIDIAC to allow the esterification reaction to occur. Furthermore, the addition of an aqueous solution is necessary to stop the reaction and precipitate the desired ester product, which in turn has the disadvantage to also hydrolyze the non-reacted protected diacerhein (CDIDIAC), which, in order to be used in another reaction cycle, has to be newly synthesized.

It is thus desirable to provide an improved method for the esterification of hyaluronic acid with hydrophobic organic compounds, such as anthracene carboxylic acid derivatives, like rhein and diacerhein.

### SUMMARY OF THE INVENTION

According to a first aspect, the present invention relates to a process for esterifying a hydroxy-group containing compound selected from the group consisting of hyaluronic acid, hyaluronic acid salts and hyaluronic acid derivatives with a hydrophobic organic compound, comprising:
(i) micronizing the hydroxy-group containing compound at reduced temperature;
(ii) reacting the hydrophobic organic compound with the micronized hydroxy-group containing compound obtained in (i) in a suitable solvent to produce the ester; and
(iii) filtrating or dialyzing the reaction mixture obtained in (ii) to obtain the desired ester.

In another aspect, the invention relates to an ester of hydrophobic compound with a hydroxy-group containing compound selected from the group consisting of hyaluronic acid, hyaluronic acid salts and hyaluronic acid derivatives obtainable according to the process of the invention.

In still another aspect, the present invention relates to a pharmaceutical composition comprising the ester obtained according to the invented process and a pharmaceutically acceptable carrier or excipient.

In a further aspect, the present invention provides for the ester obtained according to the process of the invention for treating and/or preventing cartilage damage and/or inflammation.

In a still further aspect, the invention is also directed to a method of treating and/or preventing cartilage damage and/or inflammation, to facilitate wound repair or to alleviate symptoms of inflammation and/or dryness of skin and eyes by administering a therapeutically effective amount of the ester obtained according to the process of the invention to a subject in need thereof.

### BRIEF DESCRIPTION OF THE DRAWINGS

FIG. 1 shows GPC chromatograms obtained for initial hyaluronic acid, micronized hyaluronic acid and product HA-ester.

### DETAILED DESCRIPTION OF THE INVENTION

The word “exemplary” is used here into mean “serving as an example, instance, or illustration”. Any embodiment or design described herein as “exemplary” is not necessarily to be construed as preferred or advantageous over other embodiments or designs.

In the context of the various embodiments, the following terms have the meaning indicated below unless explicitly indicated otherwise.

“Hydrophobic”, as used herein, relates to compounds that are essentially non-polar and/or essentially insoluble or very poorly soluble in or immiscible with water or other polar protic solvents. Esterification of such compounds with a hydrophilic substance thus requires specific reaction conditions. Hydrophobic compounds in the sense of the invention may have very low solubility constants in water, such as ≦10⁻⁸ or ≦10⁻⁹ or ≦10⁻¹⁰ mol/L water.

“Hyaluronic acid”, “hyaluronan” and “hyaluronate”, as interchangeably used herein, relate to polymers of disaccharides composed of D-glucuronic acid and D-N-acetylglucosamine, linked together via alternating β-1,4 and β-1,3 glycosidic bonds. Hyaluronan can be 25,000 disaccharide repeats in length and range in size from 5,000 to 20,000,000 Da in vivo. The average molecular weight in human synovial fluid is 3-4 million Da.

“About”, as used herein in connection with a numerical value or range, relates to a variation of ±20%, preferably ±10% of the value to which it refers.

“Hydrophilic”, as used herein, relates to compounds that are polar or charged and thus easily miscible or soluble in water or other polar protic solvents, but are usually not soluble in non-polar solvents.

“Reduced temperature”, as used herein, relates to a temperature below ambient, i.e. a temperature below 20° C., preferably below 15, below 10, below 5 or below 0° C.

In a first aspect, the present invention is directed to a process for the preparation of esters of a hydroxy-group containing compound selected from the group consisting of hyaluronic acid, hyaluronic acid salts and hyaluronic acid derivatives with a hydrophobic organic compound, comprising
(i) micronizing the hydroxy-group containing compound at reduced temperature;
(ii) reacting the anthracene carboxylic acid derivative with the micronized hydroxy-group containing compound obtained in (i) in a suitable solvent to produce the ester; and
(iii) filtrating or dialyzing the reaction mixture obtained in (ii) to obtain the desired ester.

The micronizing of the hydroxy-group containing compound, which usually is highly hydrophilic, is necessary to generate fine particles. These can then be dispersed in a suitable solvent and thus reacted with the hydrophobic compound without the need to solubilize the hydroxy-group containing compound in a non-polar solvent. The reduced temperature serves the purpose to avoid degradation due to the heat generated by the micronizing process. The use of the one reaction partner in solid particle form, allows simple and rapid separation of the reaction product from unreacted reactants and the solvent and thus avoids laborious and time-consuming precipitation protocols.

In various embodiments of the process, the hydrophobic organic compound is an anthracene carboxylic acid or derivative thereof. Exemplary anthracene carboxylic acid derivatives may be selected from the group consisting of rhein (4,5-dihydroxy-9,10-dihydro-9,10-dioxo-2-anthracene carboxylic acid), diacerhein (4,5-diacetoxy-9,10-dihydro-9,10-dioxo-2-anthracene carboxylic acid) and derivatives thereof. The derivatives may comprise derivatives of rhein wherein one or more of the hydroxy groups are protected by protection groups. Exemplary protection groups include, but are not limited to, t-butyl, allyl, benzyl, methoxymethyl, t-butyldimethylsilyl, tetrahydropyranyl, t-butyldiphenylsilyl, pivaloyl, and benzoyl.

In further various embodiments of the process, the hydrophobic organic compound is an anti-inflammatory drug, such as a non-steroidal anti-inflammatory drug (NSAID), or derivatives thereof. Exemplary NSAIDs include, but are not limited to, Ibuprofen, Naproxen, Fenoprofen, Ketoprofen, Flurbiprofen, Oxaprozin, Indomethacin, Sulindac, Etodolac, Diclofenac, Nabumetone, Piroxicam, Meloxicam, Tenoxicam, Droxicam, Lornoxicam, Isoxicam, Mefenamic acid, Meclofenamic acid, Flufenamic acid, Tolfenamic acid, Celecoxib, Rofecoxib, Valdecoxib, Parecoxib, Lumiracoxib, Etoricoxib, Nimesulide and Licofelone. Steroidal anti-inflammatory drugs include, but are not limited to Hydrocortisone, Prednisone, Prednisolone, Methylprednisolone, Dexamethasone, Betamethasone, Triamcinolone and Beclomethasone.

In various embodiments of the claimed process, the hyaluronic acid derivative is a hyaluronic acid ester. Exemplary esters include methyl, ethyl, n-propyl, isopropyl, n-butyl, t-butyl, isobutyl, dodecyl and benzyl esters of hyaluronic acid. In such esters, the hyaluronic acid molecules are only partially esterified so as to allow coupling of the hydrophobic compound.

In further embodiments, the hyaluronic acid may be modified, for example cross-linked. In various embodiments, cross-linked hyaluronic acid may be coupled to the hydrophobic compounds listed above, for example anthracene carboxylic acid and derivatives thereof.

In various embodiments, the hydroxy-group containing compound is hyaluronic acid or a salt thereof In a preferred embodiment, the hyaluronic acid salt is sodium hyaluronate. Other hyaluronic acid salts include, but are not limited to potassium hyaluronate, iron hyaluronate, calcium hyaluronate, magnesium hyaluronate and zinc hyaluronan.

In certain embodiments of the invention, the hydroxy-group containing compound may be a mixture of hyaluronic acid, hyaluronic acid salts and/or hyaluronic acid derivatives.

In various embodiments, the hyaluronic acid or salt or derivative thereof have a mean molecular weight of about 100,000 to about 2,500,000 Da, about 100,000 to about 1,500,000 Da, about 500,000 to about 1,000,000 Da, or about 100,000 or about 1,000,000 Da.

In various embodiments of the process according to the invention, the micronizing is performed at a temperature of about −20° C. to about −250° C., at a temperature of about −40° C. to about −200° C., at about −70° C. to about −200° C., at about 100° C. to about −200° C., or at about −150° C. to about −200° C. Performing the micronizing step at such low temperatures helps to avoid that heat generated by the micronizing procedure degrades the micronized compounds.

The low temperature can be achieved by performing the micronizing under suitable conditions, for example in a cooling medium. A suitable medium for the micronizing step that is safe, avoids degradation of the micronized compound and is essentially inert, includes, but is not limited to liquid nitrogen.

The low temperature ensures that the micronizing step (i) does not significantly alter the molecular weight of the hydroxy-group containing compound, i.e. does not lead to the degradation of the polymer.

The micronization can be done by traditional techniques, such as milling and grinding. The milling can, for example be cryomilling. In the cryomilling technique, the hydroxy-group containing compound can form a cryogenic slurry or a crystalline or amorphous material with the cooling medium, such as liquid nitrogen, and is then mechanically milled. Suitable techniques are known to those skilled in the art and equipment for such cryomilling is commercially available.

The particles generated by the micronizing step have a mean diameter of only a few micrometer, preferably even smaller, such as in the nanometer range. A preferred mean particle size is about 0.1 to 100 nm, for example 1 to 10 nm.

In various embodiments, the micronized particles are then contacted with the hydrophobic compound in a suitable solvent. In a preferred embodiment, the hydrophobic compound is solved in the solvent.

In such embodiments, the solvent may be a non-polar or a polar aprotic solvent. Suitable non-polar solvents are known in the art and include, but are not limited to n-pentane, cyclopentane, n-hexane, cyclohexane, benzene, toluene, 1,4-dioxane, diethylether, and t-butylmethylether. Suitable polar aprotic solvents include, but are not limited to, tetrahydrofurane (THF), dichloromethane (DCM), chloroform, ethylacetate, acetone, dimethylformamide (DMF), acetonitrile, and dimethylsulfoxide (DMSO).

In various embodiments, the reacting step (ii) that involves contacting the micronized hydroxy group-containing compound with the hydrophobic compound in a suitable solvent, is carried out for about 30 minutes, for about 1, for about 2, for about 4, for about 8, for about 12, for about 16, for about 20, for about 24, for about 36, for about 48 hours, or for about 72 hours.

In various embodiments, the esterification reaction, i.e. step (ii), is performed at about 10 to about 80° C., at about 20 to 70° C., or at about 30 to 60° C. In other embodiments, the reaction is carried out at a temperature of about 25, about 30, about 35, about 40, about 45, about 50, about 55, about 60, about 65, about 70, or about 75° C.

In various embodiments of the invented process, the reactants, i.e. the hydroxy group-containing compound and/or the hydrophobic compound may be activated by a reaction step (ii).

Such activation may for example be done by reacting the respective compound with an activating agent.

Exemplary activating agents include, but are not limited to 1,1′-carbonyldimidazole (CDI).

In a preferred embodiment, the hydrophobic compound, for example an anthracene carboxylic acid or derivative thereof, is activated with CDI prior to step (ii).

The activating can be carried out in a suitable solvent, for example a polar aprotic solvent, such as THF. Activation of an anthracene carboxylic acid derivative with CDI can, for example, be performed for about 30 minutes to about 4 hours at ambient temperature.

Activation of the hydroxy-group containing compound, i.e. the hyaluronan or salt or derivative thereof, may be done by coupling a suitable leaving group to one or more of the hydroxy group(s) of the hydroxy-group containing compound. Activating agents can be known esterification systems and include, but are not limited to DCC/DMAP, DIAD/PPh3, sulfonyl groups, tosyl groups, trifluoromethanesulfonate groups, imidazole and imidazole derivatives.

Processes for the activation of a reactant, suitable activating agents and reaction conditions are known to those skilled in the art.

In various embodiments of the process of the invention, step (ii) is carried out in the presence of a catalyst. In one embodiment, the catalyst is selected from the group consisting of metallic or non-metallic catalysts.

Suitable metallic catalysts include, but are not limited to, metal carbonates, metal borates, organic metal carboxylates, organic metal sulfonates, metal alkane complexes, metal acylates and metal oxides. Exemplary catalysts thus include, without being limited thereto, magnesium carbonate, zinc carbonate, zinc borate, tin(II) acetate, tin (II) octanoate tin(II) lactate, zinc acetate, aluminum acetate, tin(II) trifluoromethane sulfonate, zinc trifluoromethane sulfonate, magnesium trifluoromethane sulfonate, tin (II) methane sulfonate, tin (II) p-toluene sulfonate, dibutyltin dilaurate (DBTL), antimony oxide (Sb₂O₃), butyl titanate (Ti(IV)but), and isopropyl titanate (Ti(IV)iso).

Suitable non-metallic catalysts may be selected from the group consisting of acetic acid, methane sulfonic acid, ethane sulfonic acid, 1-propane sulfonic acid, 1-butane sulfonic acid, trifluoromethane sulfonic acid, benzene sulfonic acid, p-toluene sulfonic acid, p-xylene-2-sulfonic acid, naphthalene-1-sulfonic acid, naphthalene 2-sulfonic acid, hydrochloric acid, sulfuric acid, phosphoric acid, triethylamine, pyridine, dimethylaminopyridine, lutidine, imidazoles, 1,8-Diazabicyclo[5.4.0]undec-7-en (DBU), 1,5-Diazabicyclo(4.3.0)non-5-ene (DBN).

In various embodiments of the process, the process further comprises washing the ester obtained in step (iii) with a suitable solvent. Such washing step may include rinsing the solid ester particles with a suitable solvent. Other purification protocols may include solubilizing and recrystallizing the ester in a suitable solvent.

After the filtration step (iii) and the optional washing and/or purification steps, the ester obtained in step (iii) may be dried, for example at reduced pressure.

In various embodiments, unreacted reactants that are present in the filtrate or dialysate after step (iii) may be recovered to be reused in the reaction. This is particularly advantageous if the reactant is an activated reactant, such as an activated anthracene carboxylic acid derivative, for example CDI activated rhein or diacerhein.

In the process according to the invention, substitution ratio in the hydroxy group-containing compound of between about 0.1 and about 10% can be obtained. In a preferred embodiment, at least about 1%, at least about 2%, at least about 3, at least about 4 or at least about 5% of the hydroxy groups of the hydroxy-group containing compound are esterified with the hydrophobic compound.

The inventors of the present invention have surprisingly found that esterification of hyaluronan or salts or derivatives thereof with a suitable hydrophobic compound, which may itself have beneficial therapeutic properties, for example as an antibiotic, antifungal, anti-inflammatory, immunomodulatory, or analgesic agent, increases the stability of the hyaluronan. Moreover, the covalent coupling of a therapeutic agent to the hyaluronan helps to overcome problems connected to the administration of the hydrophobic compound and may lead to a controlled, i.e. a sustained release, of the compound.

Thus, in further embodiments of the above process, the process is used to produce an ester of hyaluronic acid or salt or derivative thereof with increased stability relative to the unreacted hyaluronic acid or salt or derivative thereof.

In another aspect, the present invention also encompasses the esters of the hydroxy group-containing compounds with a hydrophobic compound obtainable or obtained according to the invented process.

In another aspect, the present invention also covers the use of these esters for medicinal applications, such as for treating and/or preventing cartilage damage or inflammation. In further embodiments, these esters can also be used for the treatment of ocular or dermal diseases or disorders and wound and/or tissue repair. The administration can be intra-articularly, for example by injection, or topically.

In still another aspect, the invention also features a pharmaceutical composition comprising the ester obtainable according to the inventive process and a pharmaceutically acceptable carrier or excipient.

In a still further aspect, the invention also relates to a method of treating and/or preventing cartilage damage and inflammation by administering a therapeutically effective amount of the ester obtainable according to the inventive process to a subject in need thereof.

Further embodiments are within the appended claims and the examples. The following examples are for illustration only and the invention should not be construed as being limited to the exemplified embodiments.

### EXAMPLES

General Reaction Scheme for reactions with CDI Activation:

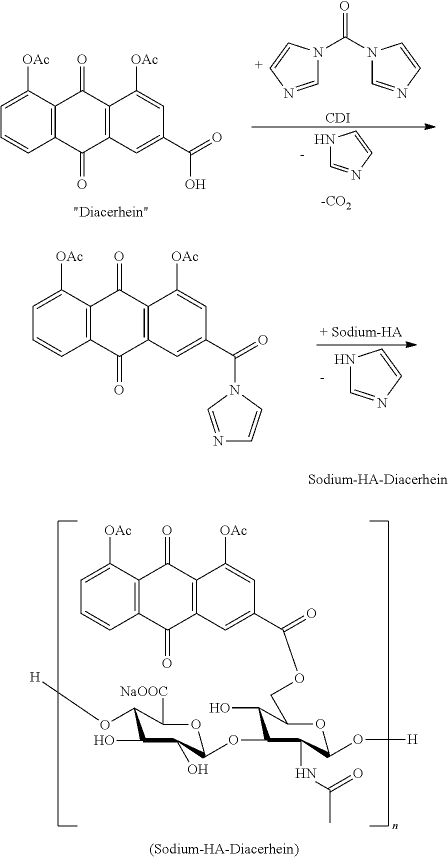

### Example 1

### Preparation of HA-Diacerhein (Small Scale: 0.5 g Scale)

0.044 g Diacerhein were suspended into 20 mL dry THF, followed by addition of 0.022 g CDI dissolved in 2 mL THF. The reaction mixture was stirred for 1 hour at room temperature until a clear solution was obtained. 0.5 g cryo-micronized HA powder were added and the suspension stirred at 70° C. for 24 hours. The reaction mixture was then filtered through a G4-fritte and washed with 150 mL dry THF. The non-soluble remaining HA product was slightly yellowish. By redissolving the product in water small amounts of remaining dispersed diacerhein could be removed by centrifugation to yield a visually clear and transparent aqueous solution.

The obtained product was analyzed by H¹-NMR-, HPLC-, UV- and LC-MS/MS-analyses, and the following results were obtained. The reaction resulted a 100% yield of HA-polymer, close to its original molecular weight with a 2% diacerhein-fimctionalization. No significant degradation of HA in the final product could be observed. The obtained product was soluble in water, only very slightly yellowish, and the aqueous solution presented the UV spectrum of diacerhein. For further qualitative characterization the HA-diacerhein product was enzymatically hydrolysed, which lead to HA-fragments (oligomers) with and without diacerhein, which could be analysed by HPLC analysis. Furthermore HA-fragments with and without diacerhein attached were identified by LC-MS/MS.

### Example 2

### Preparation of HA-Diacerhein (Larger Scale: 2.5 g Scale)

HA was micronized by cryo-milling (SPEX 6700 Freezer Mill, during 15 minutes in liquid nitrogen, applying middle impact frequency) at −196° C. The powder was dried at 0.001 bar for 24 h. Diacerhein and CDI were dried at 0.001 bar for 24 h. THF was dried over sodium and distilled thereof prior usage.

Diacerhein (0.22 g, 0.597 mmol) and CDI (0.107 g, 0.657 mmol) were dissolved in 20 mL dry THF and stirred for 1 h to yield a clear solution, followed by the addition of 2.5 g micronized dry hyaluronic acid and further stirring at 70° C. for 24 h.

After the reaction mixture had cooled down to room temperature, the suspension was filtered through a G4-frit with 4 times 250 mL dry THF, followed by drying of the obtained powder at 0.001 bar for 12 h. Non-reacted CDT activated diacerhein was recovered by evaporating the solvent.

2.5 g of the HA-diacerhein product was dissolved in 2.5 L distilled water and centrifuged at 30,000 rpm for 30 minutes at 25° C. (Optima KL 100K Ultacentrifugre (Beckman Coulter)) to remove residual diacerhein prior to lyophilization of the final pure product. All clear supernatant solutions were then combined, mixed and freeze-dried (Telstar LyoBeta 15).

Solution Appearance

A 1% (weight/weight) solution was obtained by dissolving approximately 10 mg of freeze-dried compound into 1 ml of pure MilliQ water. A clear viscous yellow solution was obtained, and no precipitation occurred even after storage or centrifugation at 14'000 rpm for 10 min.

pH Determination

pH of the above described 1% solution was determined to be 5.5 (Metrohm 691 ph-Meter operated with a Biotrode glass electrode; according to specifications received for the initial hyaluronic acid provided by TRB, pH of a 0.5% solution should be between 5.0 and 8.5).

Residual Water Content Determination

After freeze-drying, three aliquots of approximately 55 mg of the yellow compound obtained were analysed with a Karl-Fisher system (890 Titrando operating with a polytron PT 1300D), in order to determine the residual water content of the powder. The mean value was 9.3+/−0.25% residual water.

Molecular Weight Determination

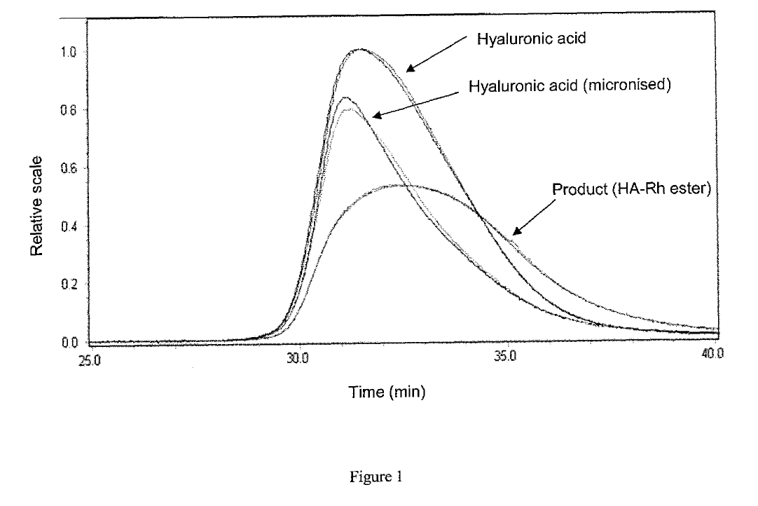

A GPC analysis of the obtained compound coupled with differential RI and triple-angle light scattering detections was performed (Waters Alliance HPLC system; Schambeck RI detector; Wyatt MiniDawn; Waters Ultrahydrogel 2000, 1000, 250 and 120; Column temperature 35° C.±2° C.; mobile phase: 50 mM sodiumdihydrogenphosphate, 150 mM sodium chloride, 0.05% sodium azide, pH 7.0; Flow rate 0.7 ml/min; analysis time 75 minutes), against a solution of initial hyaluronic acid and of micronized hyaluronic acid (cryomilling), in order to determine if the synthesis and purification process did have any significant influence on the degradation of HA towards the final envisioned molecular weight for the pharmaceutical formulation. For sample preparation, 1 mg of HA or sample to be analyzed were dissolved in 1 mL mobile phase in order to obtain a concentration of 1 mg/mL. The sample was sonicated for 1 minute and agitated for 2 hours (Vortex) until complete dissolution. 50 μL were injected twice. FIG. 1 shows the chromatographic profiles obtained for 0.1% solutions of red: initial HA; blue: micronized HA and green: final product. A slight peak broadening occurred, but no significant shift in retention time could be observed.

The calculated mean molecular weight value was 1'065'500 Daltons for the final compound (versus 1'310'000 Daltons for initial HA and 1'696'500 for micronized HA).

No significant molecular weight diminution occurred during the whole procedure (i.e. synthesis—purification—freeze-drying steps), as the final molecular weight still remained above 1'000'000 Daltons.

Diacerhein/Rhein Content Determination

After freeze-drying, twelve aliquots of the yellow compound obtained (2 mg each) were dissolved in 1 mL of pure MilliQ water, and centrifuged at 14'000 rpm for 10 minutes. No precipitation could be observed.

Absorbance of a standard solution of pure diacerhein was performed in scan mode in a UV spectrometer operating at 430 nm (CINTRA 404 UV-Vis spectrometer equipped with a Thermocell system) against a calibration curve of standard rhein in methanol, as well as of a pure rhein solution and a sample dissolved into MilliQ water. The scan profile of the samples demonstrates the presence of diacerhein in the final product

For selectivity, a wavelength of 430 nm was selected for quantitative measurements and UV absorption of the clear supernatants was determined against a calibration curve of standard rhein in methanol.

The amount of diacerhein measured in this powder sample deriving from a large scale reaction was quite homogeneous and the mean value (n=24 measurements) was 0.31% (dry weight/weight).

Reaction under same reaction and preparation conditions with less starting HA were leading to significantly higher diacerhein contents in the final product.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-38. (canceled)

39. A process for the preparation of esters of a hydroxy-group containing compound selected from the group consisting of hyaluronic acid, hyaluronic acid salts and hyaluronic acid derivatives with an anthracene carboxylic acid or derivative thereof, comprising
(i) micronizing the hydroxy-group containing compound at reduced temperature;
(ii) reacting the anthracene carboxylic acid derivative with the micronized hydroxy-group containing compound obtained in (i) in a suitable solvent to produce the ester; and
(iii) filtrating or dialyzing the reaction mixture obtained in (ii) to obtain the desired ester.

40. The process according to claim 1, wherein the hyaluronic acid derivative is a hyaluronic acid ester or cross-linked hyaluronic acid.

41. The process according to claim 1, wherein the micronizing is performed at a temperature of about −20 to about −250° C.

42. The process according to claim 1, wherein the anthracene carboxylic acid derivative is selected from the group consisting of rhein (4,5-dihydroxy-9,10-dihydro-9,10-dioxo-2-anthracene carboxylic acid), diacerhein (4,5-diacetoxy-9,10-dihydro-9,10-dioxo-2-anthracene carboxylic acid) and derivatives thereof.

43. The process according to claim 1, wherein the hyaluronic acid or salt thereof has a mean molecular weight of between about 100,000 and about 2,500,000 Da.

44. The process according to claim 1, wherein step (ii) is performed for about 30 minutes to about 72 hours.

45. The process according to claim 1, wherein step (ii) is performed at about 10 to about 80° C.

46. The process according to claim 1, wherein the solvent in step (ii) is an aprotic solvent.

47. The process according to claim 1, wherein the anthracene carboxylic acid or derivative thereof is activated prior to step (ii).

48. The process according to claim 47, wherein the activation is by reaction with 1,1′-carbonyldimidazole (CDI).

49. The process according to claim 1, wherein step (ii) is carried out in the presence of a catalyst.

50. The process according to claim 49, wherein the catalyst is selected from the group consisting of metallic or non-metallic catalysts selected from the group consisting of magnesium carbonate, zinc carbonate, zinc borate, tin(II) acetate, tin(II) octanoate, tin(II) lactate, zinc acetate, aluminum acetate, tin(II) trifluoromethane sulfonate, zinc trifluoromethane sulfonate, magnesium trifluoromethane sulfonate, tin (II) methane sulfonate, tin (II) p-toluene sulfonate, dibutyltin dilaurate (DBTL), antimony oxide (Sb₂O₃), butyl titanate (Ti(IV)but), isopropyl titanate (Ti(IV)iso), acetic acid, methane sulfonic acid, ethane sulfonic acid, 1-propane sulfonic acid, 1-butane sulfonic acid, trifluoromethane sulfonic acid, benzene sulfonic acid, p-toluene sulfonic acid, p-xylene-2-sulfonic acid, naphthalene-1-sulfonic acid, naphthalene 2-sulfonic acid, hydrochloric acid, sulfuric acid, phosphoric acid, triethylamine, pyridine, dimethylaminopyridine, lutidine, imidazoles, 1,8-Diazabicyclo[5.4.0]undec-7-en (DBU), and 1,5-Diazabicyclo(4.3.0)non-5-ene (DBN).

51. The process according to claim 1, wherein the hydroxy-group containing compound is activated prior to step (ii).

52. The process according to claim 1, wherein unreacted activated anthracene carboxylic acid or derivative thereof is recovered from the filtrate or dialysate.

53. The process according to claim 1, wherein the esterification ratio of the hydroxy groups in the hydroxy group-containing compound is between 0.1 and 10%.

54. The process according to claim 1, wherein the process is used to produce an ester of hyaluronic acid or salt or derivative thereof with increased stability relative to the unreacted hyaluronic acid or salt or derivative thereof.
